(19) United States
(12) Patent Application Publication
(10) Pub. No.: US 2008/0116711 A1
(43) Pub. Date: May 22, 2008

(54) Three-way pickup bed cover

(76) Inventor: Gary Thacker, Tucson, AZ (US)

Correspondence Address: Mark E. Ogram, 7454 E. Broadway #203, Tucson, AZ, 85710, US

(21) Appl. No.: 11/903,446

(22) Filed: Sep. 20, 2007

Related U.S. Application Data
(60) Provisional application No. 60/860,327, filed on Nov. 21, 2006.

(51) Int. Cl. B60P 7/02

(52) U.S. Cl. 296/107.07

(57) ABSTRACT

A pickup bed cover which utilizes four folding leg assemblies which are connected to the bed of the truck. On each side of the truck bed, two leg assemblies unfold and fold in unison to raise and lower each side of the cover. The cover can be raised from either side, or raised on both sides at once. The present invention includes internal locking means and a self-aligning means for said internal locking means. Further improvements are a bed mounting mechanism that allows the invention to be fitted to pickups with varying bed dimensions and a mechanism to isolate the cover from the damaging effects of bed flexing.

Priority for this application is claimed from U.S. Provisional patent application Ser. No. 60/860,327, filed on Nov. 21, 2006, and entitled “Three-way Pickup Bed Cover”, incorporated hereinto by reference.

### BACKGROUND OF THE INVENTION

This invention relates generally to truck bed covers and more particularly to security or hard tonneau covers for pickups.

Three-way pickup bed covers have been marketed since the 1960's. A generally rectangular hard cover is connected to the pickup bed with a folding leg assembly at each corner as described by U.S. Pat. No. 3,675,885, issued to Schute. The cover can be opened on either side by raising the cover and unfolding the leg assemblies. Both sides can be raised at the same time.

This type of pickup bed cover provides a variety of benefits such as:
1) When closed, the low profile of the cover allows for good rear visibility for backing up or making lane changes;
2) the closed cover protects the contents of the bed from the weather;
3) the closed cover keeps the contents of the bed out of view and provides a level of security;
4) when fully open, the cover provides access to both sides and the rear of the pickup bed;
5) the user has the option of opening only one side of the cover when only one side needs to be accessed;
6) when partially or fully open, the cover provides shade and shelter over the pickup bed;
7) in windy conditions, the user is able to open the cover on the downwind side and thereby gain some protection from the wind.

While this type of pickup bed cover does have the above benefits, it also suffers from a variety of limitations/drawbacks, including but not limited to:
1) The folding leg assemblies, which are located at each corner of the cover, do not always operate in unison on each side of the cover. As the cover is opened or closed, whenever the leg assemblies are at differing positions, the cover is forced to flex, thereby causing rapid wear on the folding leg assemblies and their attaching points.
2) To ensure that the cover stays in the raised position, the user is supposed to insert locking pins into the center hinged area of the leg assemblies, to lock them and to prevent inadvertent closure of the cover; unfortunately, most users do not take the time to do this and the cover often falls, thereby causing damage or injury.
3) Due to the leg arrangement, the cover is not very stable in the raised position and is easily damaged if the truck is driven with the cover raised.
4) To open or close the cover requires the use of two hands; the user must raise or lower the cover with one hand while using the second hand to fold the leg assemblies.
5) The cover, because of its locking facilities, provides only minimal security; the locks are usually mere hasp or draw latch arrangements on the outside and are easily breached by thieves.
6) The cover is independent of the tailgate of the truck and as such does not hold the tailgate closed when the cover is closed.

It is clear from the foregoing that there is a need for an improved three-way pickup bed cover.

### SUMMARY OF THE INVENTION

The invention is an improved three-way pickup bed cover which provides higher security, easier operation and more durability than the prior art.

The truck bed cover is attached to the bed of a truck using a folding leg assembly at each corner of the cover. On each side of the cover, the leg assemblies via an upper section of the leg assembly are joined together with a longitudinal member, causing the leg assemblies on each side to work in unison. By keeping the leg assemblies on each side at the same positions, the cover raises and lowers evenly, without flexing the cover or causing undue wear on the leg assemblies or their attaching points to the cover and bed. This also makes the cover more stable when raised, allowing the truck to be driven with the cover raised and without undue wear or damage.

Additionally, the present invention utilizes a locking mechanism that is located on the inside of the cover, where they are not accessible to thieves. These internal locks secure the folding leg assemblies in their folded; or closed position, preventing the cover from being opened. These internal locks, in the preferred embodiment, are actuated via external keyed latch handles with connecting rods or cables. Other embodiments of the invention utilize keyless entry systems and/or powered lock actuators.

The mechanism of this invention is very easy to operate. To open the cover, the user must first unlock the keyed latch handle with the key. The internal locks are released by pushing, pulling or twisting on the external latch handle, depending on the particular handle design. The user then pushes up on the grab handle on the side of the cover. Torsion springs in the folding leg assemblies counter balance the weight of the cover and a light upward push will raise the cover.

The cover raises up to the fully unfolded position of the leg assemblies, where elastic stops limit the upward travel of the legs. The torsion springs are engineered to firmly hold the cover in the raised position and prevent inadvertent closing. The user has the option of opening either or both sides of the cover at once.

To close the cover, the user simply pulls down on the grab handle, moving the cover down against the tension of the torsion springs. The cover reaches a neutral weight balance with the torsion springs just above the closed position. The user only needs to slam the cover into its internal latches to complete the closing.

A further aspect of the invention is the internal latch/clasping mechanism and latch striker alignment mechanism which provide easy latch engagement and release. As the cover is closed, an alignment arm mechanism on a leg assembly is guided into a receptacle/catch mechanism inside the cover, assuring good alignment of the latches to the strikers as the cover is closed. The user simply pulls the cover down and slam it shut, without having to guide the cover into the position since the alignment arm properly aligns the latches to engage the strikers.

While the preferred embodiment of this invention uses four latches/striker combinations, another embodiment of the invention uses a single latch/striker on each side of the cargo bed.

The alignment mechanism also prevents any side loading or binding of the latch/clasp or striker, ensuring that the latch releases easily for opening.

A further benefit of this alignment mechanism is that it captures the leg assemblies when they are in their folded positions, thereby preventing the weight of the leg assemblies from causing undue wear or stress on the upper and lower pivot points of the leg assemblies.

The internal locks and alignment mechanism inside the cover effectively lock the folding legs into their folded positions when closed. Because of this, the cover rotates about the lower pivot points of the folding leg assemblies as the opposite side of the cover is opened or closed. The lower pivot points of the leg assemblies are designed to handle the weight of the cover; in the present invention nylon bearings are used at these pivot points, which are much better suited for the load than a piece of weather strip.

Yet another improvement over the prior art is that the present invention holds the tailgate closed when the cover is closed. An overhang on the back of the cover extends down over the top of the tailgate, preventing it from being opened when the cover is closed. This unified approach eliminates the need for a separate lock to secure the tailgate.

A further improvement of the present invention is a mounting bracket that allows one embodiment of the product to be fitted to more than one model of pickup truck. Pickup beds differ significantly in their dimensions between the rails of the bed. However, all full-sized long bed pickups are very similar in bed length and in the dimensions of the tailgate openings in the rear. In the present invention, longitudinal mounting rails are fitted to each side of the pickup bed, but do not have to be fastened to the bed rails over which they reside. The mounting rails are fastened to the headboard of the bed, or elsewhere in the front corner area, and fastened to the tailgate opening at the rear of the bed.

A yet further improvement of the present invention is a means to isolate the cover from the damaging effects of bed flexing. As the truck travels over uneven terrain, the frame of the truck and the bed will flex around the longitudinal axis. This movement is very damaging to most types of truck bed covers. The present invention uses elastic or flexible connections at the rear attaching points of the mounting rails to allow the mounting rails to move laterally at the rear of the bed. As the bed flexes, the cover remains in its rectangular configuration even though the bed beneath is out of its normal shape.

The invention, together with various embodiments thereof will be more fully explained by the accompanying drawings and the following description thereof.

### DRAWINGS IN BRIEF

FIG. 1 is a view of the preferred embodiment in a closed position.

FIGS. 2A, 2B, and 2C are perspective views of the preferred embodiment showing the left side raised, the right side raised, and both sides raised.

FIGS. 3A and 3B illustrate the preferred leg assemblies together with the operation of the alignment arm.

FIG. 4 is a close-up view of a leg assembly showing the alignment arm in detail.

FIG. 5 illustrates the operation of the alignment arm.

FIG. 6 is a perspective view of the cargo bed illustrating the preferred mounting bracket used to secure the cover to the vehicle.

FIG. 7 illustrates the flex connection used in the preferred embodiment of the invention for mounting the rear brackets to the cargo bed.

### DRAWINGS IN DETAIL

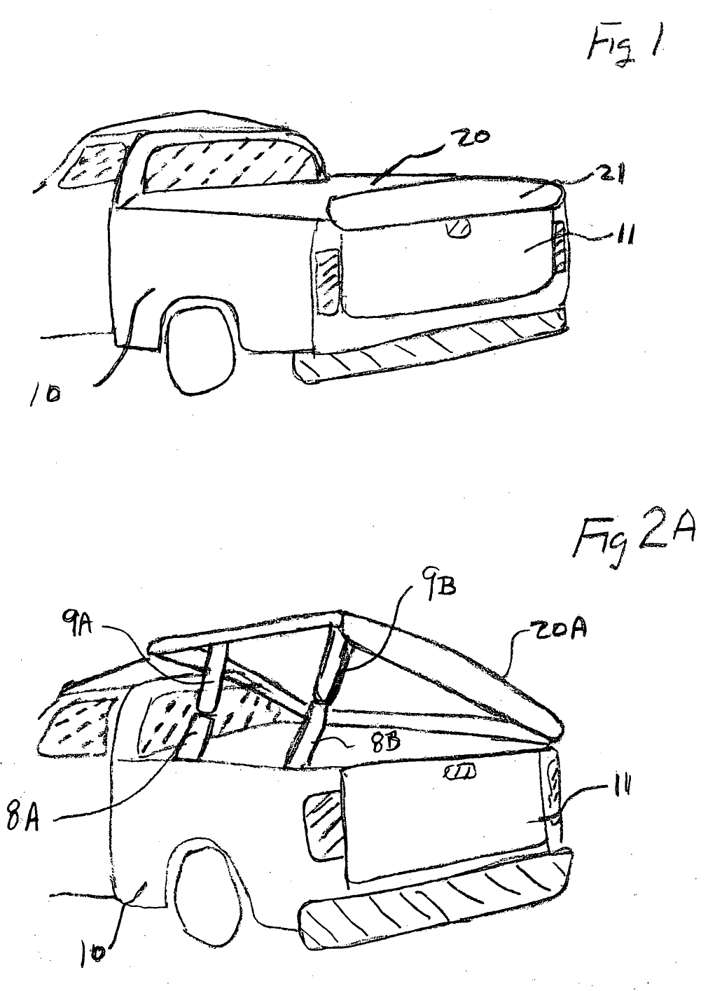

FIG. 1 is a view of the preferred embodiment in a closed position.

This perspective view from the left rear quarter shows the pickup/cargo bed 10 and tailgate 11. Cover 20 is shown in the closed position, with rear over-hang 21 extending down over the tail gate 11, thereby holding the tail gate securely closed.

In this position, the catch mechanisms are engaged keeping cover 20 closed, and by extension, also securing tail gate 11.

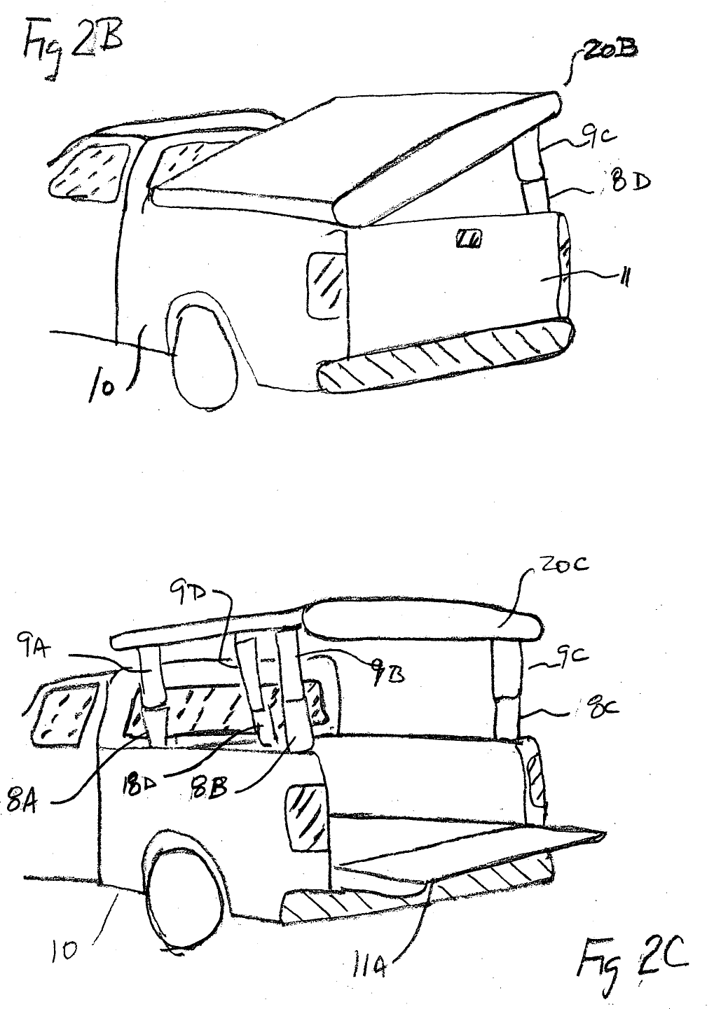

FIGS. 2A, 2B, and 2C are perspective views of the preferred embodiment showing the left side raised, the right side raised, and both sides raised for the preferred embodiment.

In FIG. 2A, cover 20 is raised on the left side. This allows access to cargo bed 10 from the left side. The forward left leg, formed by upper section 9A and lower section 8A work in unison with the left rear leg of upper section 9B and lower section 8B to maintain cover 20 raised on the left side.

Note, when a side is opened, rear over-hang 21, in some embodiments, still secures tailgate 11 in a closed position; in other embodiments overhang 21 is moved away from tail gate 11, during the raising of the side of cover 20A, thereby allowing tail gate 11 to be opened with only one side of the cover 20A open.

In like manner, FIG. 2B illustrates the right side of cover 20B in a raised position being supported by right rear leg made up of upper section 9C and lower section 8C. The forward right leg is not visible in this view.

FIG. 2C illustrates cover 20 with both sides open, a totally raised position. Tail gate 11A is in an open position. In the totally raised position, cover 20C is held by legs formed by the combinations of upper sections/lower sections 9A/8A, 9B/8B, 9C/8C, and 9D/8D.

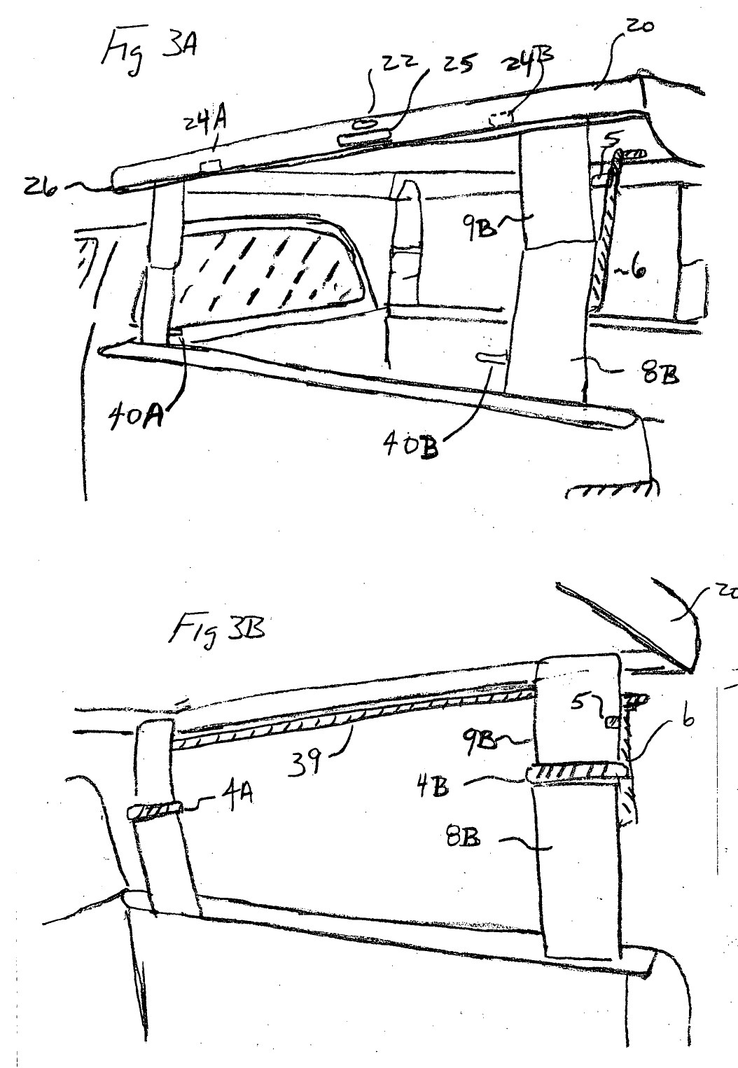

FIGS. 3A and 3B illustrate the preferred leg assemblies together with the operation of the alignment arm.

Referring to FIG. 3A, with cover 20 fully raised, latch actuator 22 is shown above grab handle 25. In the preferred embodiment, latch actuator 22 is key lockable. Rods or cables (not shown) connect latch actuator 22 with latches 24A and 24B. Latches 24A and 24B are adapted to mate with strikers 40A and 40B respectively when cover 20 is in a closed position.

As noted earlier, other embodiments of this invention utilize a single lock (the latch with striker combination) on each side of the cargo bed instead of a latch/striker combination for each leg.

While key locks for latch actuator 22 is the preferred embodiment, other embodiments of the invention use keyless entry systems and/or powered lock actuators.

Weather strip 26 seals the perimeter of the cover when it is closed.

Alignment arm 6 is secured to lower section 8B which is swivelly connected to upper section 9B. In this embodiment, at the upper end of alignment arm 6 is stop/catch pin 5, which engages upper section 9B when the leg is fully extended, as shown in FIG. 3B.

FIG. 3B illustrates the use of alignment arm 6 to secure the leg in an upright position. Lower section 8B is secured to upper section 9B using spring loading 4B which assists in overcoming the weight of the cover. As the leg enters its maximum extension stage, stop 5 of alignment arm 6 engages upper section 9B to affix the relationship of upper section 9B with lower section 8B.

Longitudinal member 39 extends between the legs and maintains the legs in unison so the legs on each side of the vehicle work as a gang. Longitudinal member 39 causes both the front and rear leg assemblies to work in unison, so that cover 20 will always open and close without twisting or flexing.

With the front and rear leg assemblies moving in unison on each side, latches 24A and 24B engage and disengage from strikers 40A and 40B in unison. In this manner, the cover is easier to open and close, flexing of the cover is minimized and undue wear on the cover and leg assemblies is minimized.

By unifying the leg assemblies on each side, the cover is much more stable when in a raised position, allowing the truck to be driven with the cover in the raised position.

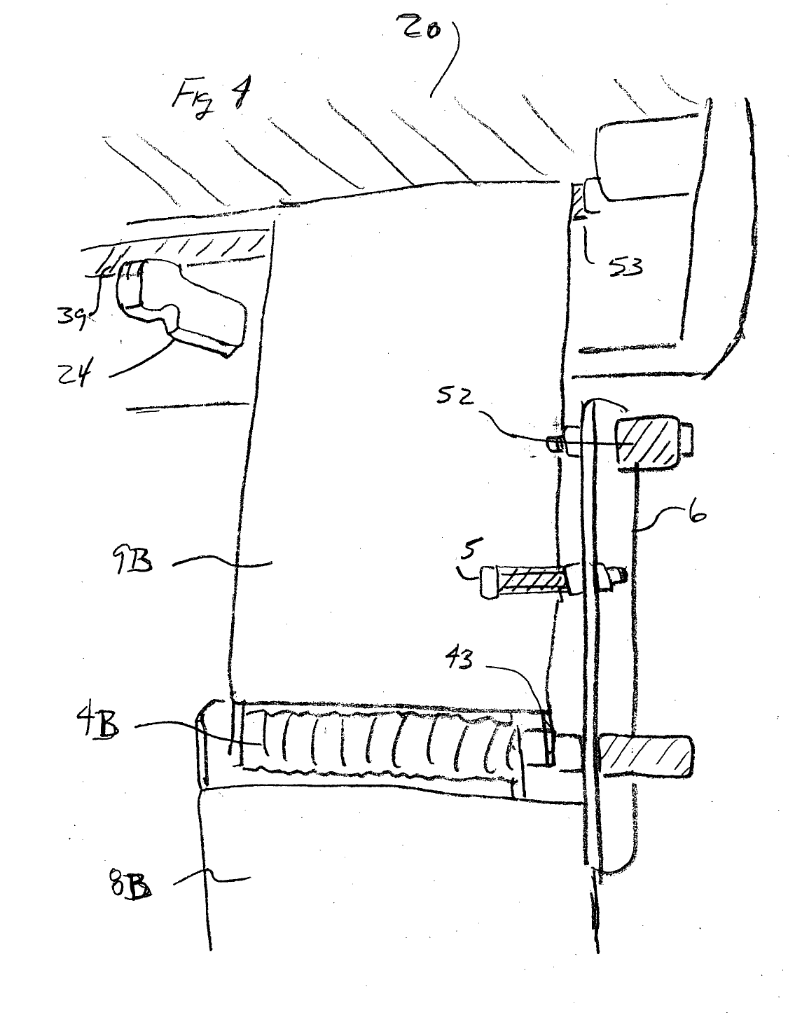

FIG. 4 is a close-up view of a leg assembly showing the alignment arm in detail.

Cover 20 is illustrated in a fully raised position by the leg assembly having upper section 9B and lower section 8B. Spring 4B tends to move upper section 9B and lower section 8B into alignment to compensate for the weight of the assembly.

Latch 24 is aligned to engage a striker, not shown, when the leg is folded to move cover 20 into a closed position. As the cover closes, the leg assembly folds down, rotating about cover pivot point 53 at the top, center hinge bolt 43 in the middle, and lower pivot bolts (not shown) at the bottom.

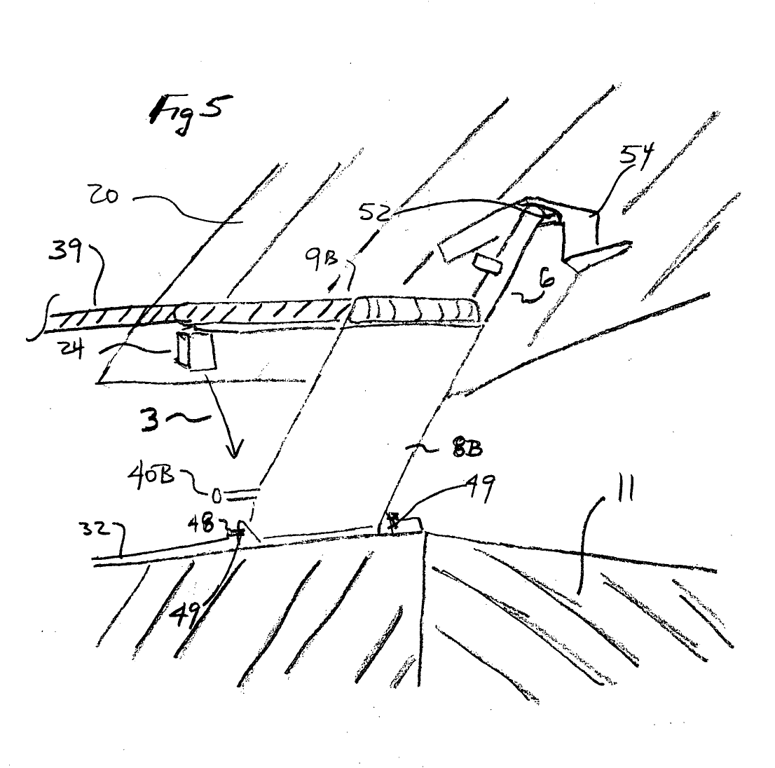

All leg assemblies are essentially the same. Cover 20 is shown in the fully raised position above pickup bed 10. Longitudinal member 39, shown in FIGS. 4 and 5, is hidden inside the cover and extends between the upper sections of two legs on each side of the cargo bed. In the preferred embodiment, upper section 9B is welded to longitudinal member 39. At cover 20, upper section 9B and longitudinal member 39 rotate about upper pivot point 53. The bottom end of upper section 9B is hinged to lower section 8B about center hinge bolt 43.

Mounted concentric to center hinge bolt 43 are torsion spring 4B. Each end of torsion spring 4B has a leg that presses against lower section 8B at one end and upper section 9B at the other end. This spring tension biases the leg assembly toward the open, or raised position.

Torsion spring 4B is engineered to counter balance the weight of cover 20, making it easy to open. When in the fully open position, torsion spring 4B is also engineered to firmly hold the cover in the raised position, so that the user must pull down against the spring tension to close the cover. This, together with “slam” latches employed in this embodiment, allows one-handed closing of the cover by simply pulling the cover down.

It is readily apparent to those skilled in the art that many types of springs, actuators, or gas/fluid cylinders are useable to bias the leg assemblies toward their open position.

The bottom end of lower section 8B rotates on lower pivot bolt which are connected to a mounting rail (now shown) secured to the cargo bed. In the preferred embodiment, all pivot bolts rotate inside nylon bearings, which are well known to those skilled in the art.

Alignment arm 6 is attached to lower section 8B and, in a fully open position, stop 5 contacts the back side of upper section 9B to limit the opening of the leg assembly. In the preferred embodiment, stop 5 is an elastic material to prevent “clanging” when the cover is fully opened; in this embodiment it is a piece of rubber hose mounted on a bolt. It is readily apparent to those skilled in the art that other types of stops or limiters are useable.

The position of stop 5 is chosen to allow torsion spring 4B to hold the cover firmly open, yet the average person can easily pull the cover down against the spring tension.

At the top of alignment arm 6, alignment roller 52 is shown, and serves the function of providing an alignment between the latch 24 and its associated striker during the closing of the cover.

FIG. 5 illustrates the operation of the alignment arm.

In the preferred embodiment, latch 24 is visible from the inside of the cover and is only accessible when the cover is raised. This provides additional security for the invention.

Latch 24 engages striker 40B when the cover closes.

Mounting rail 32 has devises 49 welded thereto and are used to secure the lower section 8B to the mounting rail 32 via pivot bolts 48.

Alignment roller 52 is shown mounted at the top of alignment arm 6. Mounted to cover 20 is alignment receptacle 54. During closure of cover 20, alignment roller 52 engages with alignment receptacle 54 so that the bending of the legs upper section 9B with lower section 8B is controlled so that latch 24 properly engages striker 40B, as indicated by arrow 3. Longitudinal member 39 (discussed before) assures that a single alignment arm is all that is necessary for proper control of both legs.

In the preferred embodiment, any exposed bolt threads are covered by rubber hose for safety.

It is readily apparent to those skilled in the art that different types of locks and strikers could be arranged in different locations to achieve the same result. It is also readily apparent to those skilled in the art that the desired result is achievable with any type of lock that engages any kind of striker or latching point located along the same axis as the lower leg hinge points.

Because the longitudinal member (not shown in this figure) causes both leg assemblies on each side of the cover to work in unison, only one alignment arm is required for each side of the cargo bed.

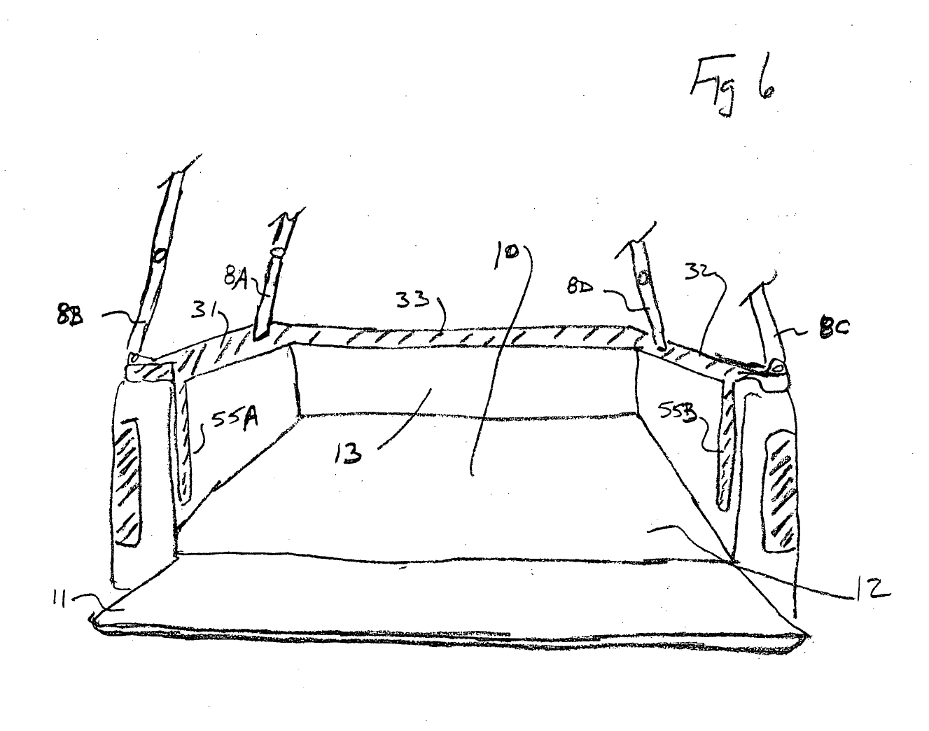

FIG. 6 is a perspective view of the cargo bed illustrating the preferred mounting bracket used to secure the cover to the vehicle.

In this illustration, for simplicity of illustration, the cover is not shown. Tailgate 11 is down, showing the tailgate opening 12. The headboard 13 of the pickup/cargo bed is behind the cab of the truck (not shown). In the preferred embodiment, headboard mounting rail 33 is fastened to headboard 13. In some embodiments, headboard mounting rail 33 serves as a mounting base for optional overhead racks for carrying ladders and other long items above the cover.

At each end of headboard rail 33, is left mounting rail 31 and right mounting rail 32 which are attached to the headboard rail 33 via bolts, welds or other methods of securing the items. In alternative embodiments, the headboard mounting rails 33 is not utilized and the left mounting rail 31 and the right mounting rail 32 are fastened directly to headboard 13 or elsewhere in the front region of the bed.

In yet other embodiments, the headboard mounting rail is eliminated entirely with the side rails are attachable to the headboard region.

In the preferred embodiment, left mounting rail 31 and right mounting rail 32 are “free floating” and are not secured to the sides of the cargo bed except at the front (the headboard rail 33) and at the rear of the cargo bed.

At the rear of the pickup bed 10, rear mounting brackets 55A and 55B are secured to the ends of left mounting rail 31 and right mounting rail 32 respectively. In the preferred embodiment, rear mounting bracket 55A is welded to the left mounting rail 31; rear mounting rail 55B is welded to the right mounting rail 32.

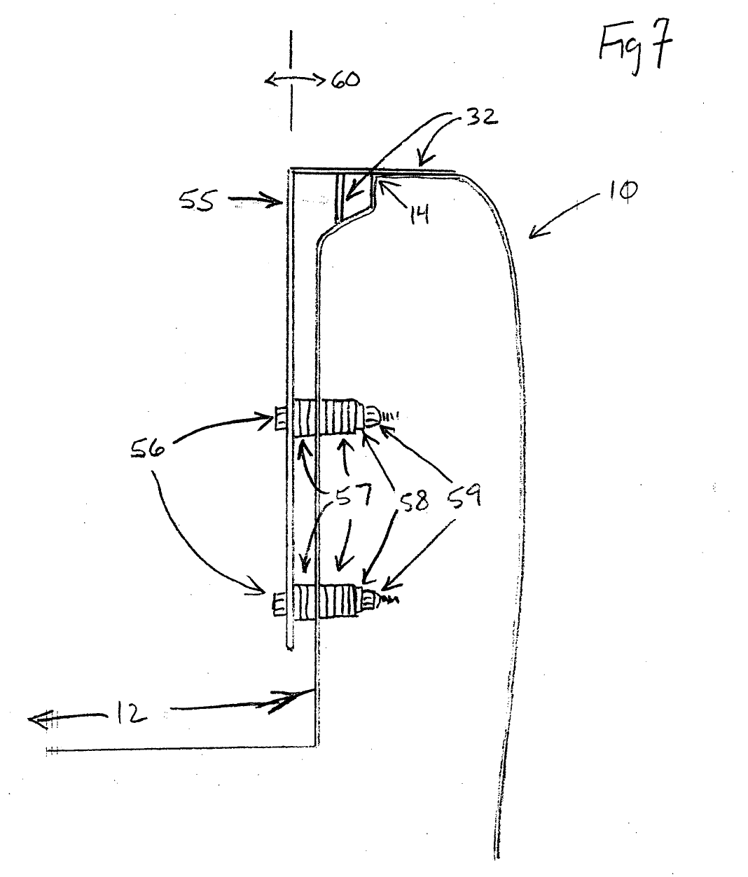

In the preferred embodiment, rear mounting brackets 55A and 55B are attached into the tailgate opening 12 with a flex connection (described in FIG. 7). With mounting rails 31 and 32 securely mounted at both the front and rear of pickup bed 10, the resulting structure is firmly affixed to cargo bed 10.

This arrangement allows for versatile manufacture as the dimensions between the bed rails varies across makes and models of pickups. Eliminating the need to attach directly to the bed rails makes it possible for one model of this invention to fit various makes and models of pickups.

FIG. 7 illustrates the flex connection used in the preferred embodiment of the invention for mounting the rear brackets to the cargo bed.

An end view of right mounting rail 32 is shown atop pickup bed rail 14. Rear mounting bracket 55B is shown in cross section, extending down into tailgate opening 12. Rear mounting bolts are shown extending through rear mounting bracket 55, elastic spacers 57, tailgate opening 12, and more elastic spacers 57. Elastic spacers in the preferred embodiment are ideally rubber washers which allow for compression/expansions of the connection.

These parts are held in place with flat washers 58 and in the preferred embodiment, nylon insert lock nuts 59. To fit tailgate openings 12 of various dimensions, varying numbers of elastic washers 57 are placed on the inside or outside of the tailgate opening. In this example, three elastic washers 57 are used at each mounting opening inside the tailgate opening, and five elastic washers 57 are used on the outside. This arrangement, permitting varying numbers of elastic washers 57, allows one model of the invention to be fitted to various makes and models of pickups.

An even more important feature of the use of the elastic washers 57 is that the mounting rails are permitted to move laterally as the pickup bed flexes, indicated by the arrow and the numeral 60, such as when the pickup is driven off-road. This lateral movement isolates the cover from the damaging effects of bed flexing, thereby extending the life of the cover by reducing or eliminating metal fatigue within the cover.

It is clear that the present invention creates a highly improved and more durable pickup bed cover.

What is claimed is:

1. A truck bed cover comprising:
a) a bed cover configured to mate with a bed of a truck;
b) four legs, each of said four legs having a lower section swivelly secured to an upper section, a first end of the lower section of each leg swivelly securable to the bed of said truck, a second end of the upper section of each leg swivelly secured to said bed cover;
c) at least one clasping mechanism secured to the bed cover on each side; and,
d) at least one striker, on each side of the bed, each striker positioned to engage one of said at least one clasping mechanisms when said bed cover is in a closed position.

2. The truck bed cover according to claim 1, wherein said at least one striker is securable to the bed of said truck.

3. The truck bed cover according to claim 1, wherein each of said at least one striker is secured to the lower section of each of the at least four legs.

4. The truck bed cover according to claim 1, wherein said at least clasping mechanism is positioned such that, when said bed cover is in a closed position, said at least one clasping mechanism is contained within the bed cover and the bed of the truck.

5. The truck bed cover according to claim 1, further including two longitudinal members, each longitudinal members, when said truck bed cover is secured to the truck, extending parallel to opposing sides of said truck bed and secured to an upper section of two of said four legs.

6. The truck bed cover according to claim 5, wherein each of said longitudinal members are attached proximate to said bed cover.

7. The truck bed cover according to claim 5, further including,
a) a first alignment arm secured at a first end to the lower section of one of said legs; and,
b) a first catch mechanism secured to the bed cover and positioned to engage a second end of said first alignment arm such that, during lowering of said bed cover, one of said at least one clasping mechanisms is aligned to engage one of said at least one strikers.

8. The truck bed cover according to claim 7, wherein said first alignment arm includes a stop mechanism positioned to engage an upper section of said leg when said bed cover is a full open position.

9. The truck bed cover according to claim 7, further including,
a) a second alignment arm secured at a first end to the lower section of one of said legs on an opposing side of said bed cover from said first alignment arm; and,
b) a second catch mechanism secured to the bed cover and positioned to engage a second end of said second alignment arm such that, during lowering of said bed cover, one of said at least one clasping mechanisms is aligned to engage one of said at least one strikers.

10. The truck bed cover according to claim 5, further including:
a) a left mounting rail wherein the lower section of a first leg and the lower section of the second leg are swivelly secured thereto, a first end thereof securable to a front panel of said truck bed;
b) a right mounting rail wherein the lower section of a third leg and the lower section of the fourth leg are swivelly secured thereto, a first end thereof securable to a front panel of said truck bed;
c) a left floating bracket secured to a second end of said left mounting rail and securable via a first flex connection to a rear portion of said truck bed; and,
d) a right floating bracket secured to a second end of said right mounting rail and securable via a second flex connection to a rear portion of said truck bed.

11. The truck bed cover according to claim 10, further including a front bracket securable to a front panel of said truck bed, said front bracket secured to a first end of said left mounting rail and a first end of the right mounting rail.

12. The truck bed cover according to claim 10, wherein said first flex connection and the second flex connection include multiple elastic washers interposed between the truck bed and the left and right floating bracket.

13. The truck bed cover according to claim 5, wherein said bed cover is configured to overlap a tail gate of said truck bed when said bed cover is in a closed position.

14. A mechanism for raising and lowering a bed cover for a truck comprising:
a) four legs, each of said four legs having a lower section swivelly secured to an upper section, a first end of the lower section of each leg swivelly securable to the bed of the truck, a second end of the upper section of each leg swivelly securable to the bed cover;
b) at least one clasping mechanism; and,
c) at least one striker, each of said strikers positioned to engage one of said at least one clasping mechanisms when said bed cover is in a closed position.

15. The mechanism according to claim 14, further including:
a) a first longitudinal member extending from the upper section of the first leg to the upper section of the second leg; and,
b) a second longitudinal member extending from the upper section of the third leg to the upper section of the fourth leg.

16. The mechanism according to claim 14, further including:
a) a first alignment arm secured at a first end to the lower section of one of said legs; and,
b) a first catch mechanism configured to engage a second end of said first alignment arm and securable to the bed cover, such that, during lowering of said bed cover, one of said at least one clasping mechanisms is aligned to engage one of said at least one strikers.

17. The mechanism according to claim 14, further including:
a) a left mounting rail wherein the lower section of a first leg and the lower section of the second leg are swivelly secured thereto;
b) a right mounting rail wherein the lower section of a third leg and the lower section of the fourth leg are swivelly secured thereto;
c) a front bracket securable to a front panel of said truck bed and secured to a first end of said left mounting rail and a first end of the right mounting rail;
d) a left floating bracket secured to a second end of said left mounting rail and securable via a first flex connection to a rear portion of said truck bed; and,
e) a right floating bracket secured to a second end of said right mounting rail and securable via a second flex connection to a rear portion of said truck bed.

18. A truck comprising:
a) a vehicle having a cargo bed;
b) a bed cover configured to mate with the cargo bed;
c) four legs, each of said four legs having a lower section swivelly secured to an upper section, a first end of the lower section of each leg swivelly secured to the cargo bed, a second end of the upper section of each leg swivelly secured to said bed cover;
d) at least one clasping mechanism secured to each side of the bed cover; and,
e) at least one striker on each side of the bed cover, each of said strikers positioned to engage one of said at least four clasping mechanisms when said bed cover is in a closed position.

19. The truck according to claim 18, further including at least two longitudinal members, each longitudinal member, extending parallel to opposing sides of said cargo bed and secured to an upper section of two of said four legs.

20. The truck according to claim 18, further including,
a) a first alignment arm secured at a first end to the lower section of one of said legs; and,
b) a first catch mechanism secured to the bed cover and positioned to engage a second end of said first alignment arm during lowering of said bed cover such that at least one of said clasping mechanisms is aligned to engage one of said strikers.

21. The truck according to claim 20, further including,
a) a second alignment arm secured at a first end to the lower section of one of said legs on an opposing side of said bed cover from said first alignment arm; and,
b) a second catch mechanism secured to the bed cover and positioned to engage a second end of said second alignment arm during lowering of said bed cover such that at least one of said mechanisms is aligned to engage one strikers.

22. The truck bed cover according to claim 18, further including:
a) a left mounting rail wherein the lower section of a first leg and the lower section of the second leg are swivelly secured thereto, a first end of said left mounting rail securable to a front panel of said cargo bed;
b) a right mounting rail wherein the lower section of a third leg and the lower section of the fourth leg are swivelly secured thereto, a first end of the right mounting rail securable to the front panel of the cargo bed;
c) a left floating bracket secured to a second end of said left mounting rail and secured via a first flex connection to a rear portion of said cargo bed; and,
d) a right floating bracket secured to a second end of said right mounting rail and secured via a second flex connection to a rear portion of said cargo bed.

23. The truck bed cover according to claim 22, wherein said first flex connection and the second flex connection include elastic washers interposed between the cargo bed and the left and right floating bracket.

24. The truck bed cover according to claim 22, further including a front bracket securable to a front panel of said cargo bed, said front bracket secured to a first end of said left mounting rail and a first end of the right mounting rail.
